(19) United States
(12) Patent Application Publication
(10) Pub. No.: US 2017/0077722 A1
(43) Pub. Date: Mar. 16, 2017

(54) BATTERY PACK, CELL MODULE AND CELL MODULE ASSEMBLY

(71) Applicant: Eun-Ey JUNG, Paju-si, Gyeonggi-do (KR)

(72) Inventor: Eun-Ey JUNG, Paju-si, Gyeonggi-do (KR)

(21) Appl. No.: 15/128,763

(22) PCT Filed: Mar. 24, 2015
(86) PCT No.: PCT/KR2015/002887

§ 371 Date: Sep. 23, 2016

(30) Foreign Application Priority Data
Mar. 24, 2014 (KR) 10-2014-0034292
Mar. 24, 2015 (KR) 10-2015-0040688

(51) Int. Cl. H02J 7/00; H01M 2/10; H01M 10/44; H01M 10/42

(52) U.S. Cl. CPC H02J 7/0021; H01M 10/425; H01M 2/1022; H01M 2/1072; H02J 7/0045; H01M 10/441; H01M 2010/4271; H01M 2010/4278; H01M 2220/20; H01M 2220/30; H02J 2007/0096; H04W 88/02

(57) ABSTRACT

Provided are a battery pack, a cell module and a cell module assembly. Herein, the battery pack includes at least one cell module, and a communication connector connected with the at least one cell module to wiredly communicate with external equipment, in which the at least one cell module is connected with the communication connector to control charge and discharge of the cell according to a control command received from the external equipment, and the external equipment is installed with an external hardware device in which a battery management system transmitting the control command is implemented or software implementing the battery management system.

### TECHNICAL FIELD

The present invention relates to a battery pack, a cell module and a cell module assembly.

### BACKGROUND ART

Electronic devices such as laptops and mobile phones and vehicles receive required energy through a battery. Such a battery may be manufactured by a battery pack including a battery cell and various circuits.

In the battery pack, a plurality of battery cells are connected to each other in series or in parallel, and in this case, the battery pack is controlled by a battery management system (hereinafter, referred to as ‘BMS’). The BMS is configured by hardware constituted by a printed circuit board (PCB) and BMS software, and the combined hardware and software is referred to as the BMS.

In this case, in the related art, the battery pack needs to embed the BMS hardware.

### DISCLOSURE

### Technical Problem

The present invention has been made in an effort to provide a battery pack, a cell module and a cell module assembly without battery management system (BMS) hardware.

### Technical Solution

An exemplary embodiment of the present invention provides a battery pack including: at least one cell module; and a communication connector connected with the at least one cell module to wiredly communicate with external equipment, in which the at least one cell module is connected with the communication connector to control charge and discharge of the cell according to a control command received from the external equipment, and the external equipment is installed with an external hardware device in which a battery management system transmitting the control command is implemented or software implementing the battery management system.

The at least one cell module may include a wired communication type cell module which further includes a wired communication terminal and a wired communication module which are wiredly connected with the communication connector to receive the control command, and a CPU that controls the charging and the discharging according to the control command received through the wired communication terminal and the wired communication module, and be connected with each other among the plurality of wired communication type cell modules.

The at least one cell module may include a wireless communication type cell module including a wireless antenna and a wireless communication module, and a CPU that controls charging and discharging of the cell according to a control command received through the wireless antenna and the wireless communication module, and a combined communication type cell module including a wired communication terminal and a wired communication module which are wiredly connected with the communication connector and the wired communication type cell module, a wireless antenna that wirelessly communicates with the wireless communication type cell module and a wireless communication module connected with the wireless antenna, and a CPU that receives a control command from the external equipment through the wired communication terminal and the wired communication module, controls charging and discharging of the cell according to the control command, and transfers the control command to the wireless communication type cell module connected through the wireless antenna.

The battery pack may further include a battery positive terminal and a battery negative terminal, and a power connector for supplying power from the external equipment, in which the wired communication type cell module, the wireless communication type cell module, and the combined communication type cell module may further include a cell including a cell module positive terminal connected with the battery positive terminal and a cell module negative terminal connected with the battery negative terminal, a DC power terminal connected with the battery positive terminal and the battery negative terminal to receive battery voltage, and a DC-DC converter positioned between the cell and the DC power terminal and charging DC power received from the DC power terminal in the cell.

The wired communication type cell module may further include a controller power terminal connected with the power connector to supply the power received from the external equipment to the CPU and the wired communication module, and the wired communication terminal, the controller power terminal, and the DC power terminal may be connected to each other among a plurality of first cell modules.

The wireless communication type cell module may further include a controller power terminal connected with the power connector to supply the power received from the external equipment to the CPU and the wireless communication module, the combined communication type cell module may further include a controller power terminal connected with the power connector to supply the power received from the external equipment to the CPU, the wireless communication module and the wired communication module, the wired communication terminal, the controller power terminal and the DC power terminal may be connected with each other between the combined communication type cell module and at least one wired communication type cell module, the wireless communication terminal, the controller power terminal and the DC power terminal may be connected with each other between the combined communication type cell module and at least one wireless communication type cell module, and the controller power terminal and the DC power terminal may be connected with each other between the at least one wired communication type cell module and the at least one wireless communication type cell module.

The battery pack may further include a battery positive terminal and a battery negative terminal; a power connector for supplying the power from the external equipment; and an external power terminal.

Herein, the wired communication type cell module, the wireless communication type cell module, and the combined communication type cell module may further include a cell including a cell module positive terminal connected with the battery positive terminal and a cell module negative terminal connected with the battery negative terminal, an AC power terminal connected with the external power terminal to receive external AC voltage, and an AC-DC converter positioned between the cell and the AC power terminal and converting AC power received from the AC power terminal to DC power to charge the cell.

The wired communication type cell module may further include a controller power terminal connected with the power connector to supply the power received from the external equipment to the CPU and the wired communication module, the wireless communication type cell module may further include a controller power terminal connected with the power connector to supply the power received from the external equipment to the CPU and the wireless communication module, the combined communication type cell module may further include a controller power terminal connected with the power connector to supply the power received from the external equipment to the CPU, the wireless communication module and the wired communication module, the wired communication terminal, the controller power terminal and the AC power terminal may be connected with each other between the combined communication type cell module and at least one wired communication type cell module, the wireless communication terminal, the controller power terminal and the AC power terminal may be connected with each other between the combined communication type cell module and at least one wireless communication type cell module, and the controller power terminal and the AC power terminal may be connected with each other between the at least one wired communication type cell module and the at least one wireless communication type cell module.

Another exemplary embodiment of the present invention provides a battery pack including at least one cell module, in which the at least one cell module includes a wired communication type cell module including a CPU controlling charging and discharging of a cell according to a control command received through wired communication, a wireless communication type cell module including a CPU controlling charging and discharging of the cell according to the control command received from the external equipment through wireless communication, and a combined communication type cell module that controls the charging and discharging of the cell according to the control command received from the external equipment through wireless communication and transfers the control command to the wired communication type cell module through the wired communication, and the external equipment is installed with an external hardware device in which a battery management system transmitting the control command is implemented or software implementing the battery management system.

The battery pack may further include a battery positive terminal and a battery negative terminal, and a power connector for supplying power from the external equipment, in which the wired communication type cell module, the wireless communication type cell module, and the combined communication type cell module may charge the cell by battery voltage received from the battery positive terminal and the battery negative terminal, and supply the power of the CPU as the power received from the power connector.

The wired communication type cell module, the wireless communication type cell module, and the combined communication type cell module may further include a cell including a cell module positive terminal connected with the battery positive terminal and a cell module negative terminal connected with the battery negative terminal, a DC power terminal connected with the battery positive terminal and the battery negative terminal to receive battery voltage, and a DC-DC converter positioned between the cell and the DC power terminal and charging DC power received from the DC power terminal in the cell.

The wired communication type cell module may further include a controller power terminal connected with the power connector to supply the power received from the external equipment to the CPU and the wired communication module, the wireless communication type cell module may further include a controller power terminal connected with the power connector to supply the power received from the external equipment to the CPU and the wireless communication module, the combined communication type cell module may further include a controller power terminal connected with the power connector to supply the power received from the external equipment to the CPU, the wireless communication module and the wired communication module, the wired communication terminal, the controller power terminal and the DC power terminal may be connected with each other between the combined communication type cell module and at least one wired communication type cell module, the wireless communication terminal, the controller power terminal and the DC power terminal may be connected with each other between the combined communication type cell module and at least one wireless communication type cell module, and the controller power terminal and the DC power terminal may be connected with each other between the at least one wired communication type cell module and the at least one wireless communication type cell module.

The battery pack may further include a battery positive terminal and a battery negative terminal, a power connector for supplying the power from the external equipment, and an external power terminal, in which the wired communication type cell module, the wireless communication type cell module, and the combined communication type cell module may charge the cell by battery voltage received from the external power terminal, and supply the power of the CPU as the power received from the power connector.

The wired communication type cell module, the wireless communication type cell module and the combined communication type cell module may further include a cell including a cell module positive terminal connected with the battery positive terminal and a cell module negative terminal connected with the battery negative terminal, an AC power terminal connected with the external power terminal to receive external AC voltage, and an AC-DC converter positioned between the cell and the AC power terminal and converting AC power received from the AC power terminal to DC power to charge the cell.

The wired communication type cell module may further include a controller power terminal connected with the power connector to supply the power received from the external equipment to the CPU and the wired communication module, the wireless communication type cell module may further include a controller power terminal connected with the power connector to supply the power received from the external equipment to the CPU and the wireless communication module, the combined communication type cell module may further include a controller power terminal connected with the power connector to supply the power received from the external equipment to the CPU, the wireless communication module and the wired communication module, the wired communication terminal, the controller power terminal and the AC power terminal may be connected with each other between the combined communication type cell module and at least one wired communication type cell module, the wireless communication terminal, the controller power terminal and the AC power terminal may be connected with each other between the combined communication type cell module and at least one wireless communication type cell module, and the controller power terminal and the AC power terminal may be connected with each other between the at least one wired communication type cell module and the at least one wireless communication type cell module.

Yet another exemplary embodiment of the present invention provides a cell module including: a cell including a cell module positive terminal and a cell module negative terminal to be charged and discharged; a CPU executing battery management system software controlling charging and discharging of the cell; and a communication module and a communication terminal downloading the battery management system software wiredly or wirelessly to transfer the battery management system software to the CPU.

The communication module and the communication terminal may communicate with other cell modules wiredly or wirelessly to transceive the control command.

The cell module may further include a power terminal to which power is applied from the outside; a converter converting the power to charge the power in the cell; a switch positioned between the cell and the converter to be turn on or off according to a control of the CPU; a current sensor positioned between the cell and the converter to output measured current to the CPU; and a temperature sensor measuring a temperature of the cell to output the measured temperature to the CPU.

Still another exemplary embodiment of the present invention provides a cell module assembly including two or more cell modules which include a battery cell including a cell module positive terminal and a cell module negative terminal and having a predetermined shape; and a printed circuit board connected with the battery cell on one side of the battery cell and including a circuit unit for charging and discharging the battery cell, in which the cell modules are disposed in two or more cell trays.

The battery cell may have a hexahedral shape, and the printed circuit board may be coupled to four left and right sides or front and rear sides of the battery cell.

The cell module positive terminal and the cell module negative terminal may be positioned on a different surface from the printed circuit board.

A plurality of cell trays may be stacked.

The plurality of cell trays may be stacked in a drawer structure.

### Advantageous Effects

According to the exemplary embodiment of the present invention, the hardware and the software of the BMS are separated from each other, thereby reducing costs of the hardware and adding various functions to the BMS and the battery system.

Further, a cell module embedding a central processing unit (CPU) (alternatively, a microprocessor) is configured and a battery is configured by using one or more cell modules. As such, the BMS software is downloaded to the CPU of any one cell module among one or more cell modules to allow the cell module to manage the remaining cell modules.

Further, the BMS software is downloaded to external equipment which communicates with the battery and the external equipment performs a BMS function to communicate with one or more cell modules, thereby managing the battery.

### DESCRIPTION OF THE DRAWINGS

FIG. 1 illustrates a configuration of a DC input wired communication type cell module according to an exemplary embodiment of the present invention.

FIG. 2 illustrates a configuration of a DC input wireless communication type cell module according to another exemplary embodiment of the present invention.

FIG. 3 illustrates a configuration of a DC input combined communication type cell module according to yet another exemplary embodiment of the present invention.

FIG. 4 illustrates a configuration of an AC input wired communication type cell module according to still another exemplary embodiment of the present invention.

FIG. 5 illustrates a configuration of an AC input wired communication type cell module according to still yet another exemplary embodiment of the present invention.

FIG. 6 illustrates a configuration of an AC input combined communication type cell module according to still yet another exemplary embodiment of the present invention.

FIG. 7 illustrates a connection configuration between a battery and a battery control system according to an exemplary embodiment of the present invention.

FIG. 8 illustrates a connection configuration between a battery and a battery control system according to another exemplary embodiment of the present invention.

FIG. 9 illustrates a connection configuration between a battery and a battery control system according to yet another exemplary embodiment of the present invention.

FIG. 10 illustrates a connection configuration between a battery and a battery control system according to still another exemplary embodiment of the present invention.

FIG. 11 illustrates a connection configuration between a battery and a battery control system according to still yet another exemplary embodiment of the present invention.

FIG. 12 illustrates a cell module according to an exemplary embodiment of the present invention.

FIGS. 13 to 15 illustrate cell modules according to another exemplary embodiment of the present invention.

FIG. 16 illustrates a cell module assembly according to an exemplary embodiment of the present invention.

FIG. 17 illustrates a cell module assembly according to another exemplary embodiment of the present invention.

FIG. 18 illustrates a cell module assembly according to yet another exemplary embodiment of the present invention.

FIG. 19 illustrates a cell module assembly according to still another exemplary embodiment of the present invention.

FIG. 20 illustrates a cell module assembly according to another exemplary embodiment of the present invention.

FIG. 21 illustrates stacked cell module assemblies according to an exemplary embodiment of the present invention.

FIG. 22 illustrates stacked cell module assemblies according to another exemplary embodiment of the present invention.

FIG. 23 illustrates stacked cell module assemblies according to yet another exemplary embodiment of the present invention.

FIG. 24 illustrates stacked cell module assemblies according to still another exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements.

In addition, the terms “-er”, “-or” and “module” described in the specification mean units for processing at least one function and operation and can be implemented by hardware components or software components and combinations thereof.

In this specification, a cell module may be configured by one cell or a cell set in which many cells are combined and connected to each other in parallel or in series. Further, cell modules configured by various circuits are included and the cell modules is commonly called a cell module.

Further, a terminal may be a connector or a terminal end according to application of a product, but in the exemplary embodiment of the present invention, the terminal or the connector is mixed.

Hereinafter, a battery pack, a cell module and a cell module assembly according to an exemplary embodiment of the present invention will be described in detail with reference to the accompanying drawings.

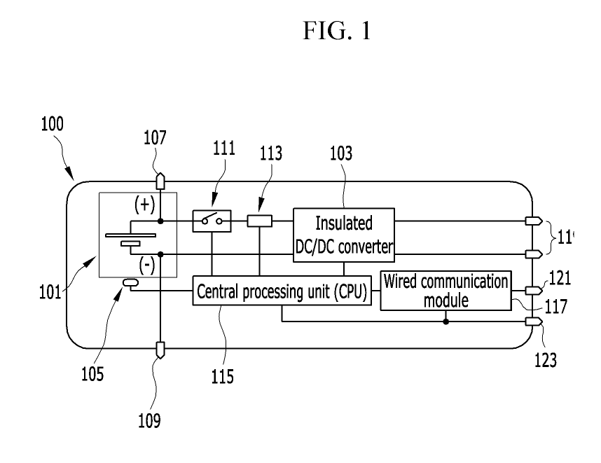

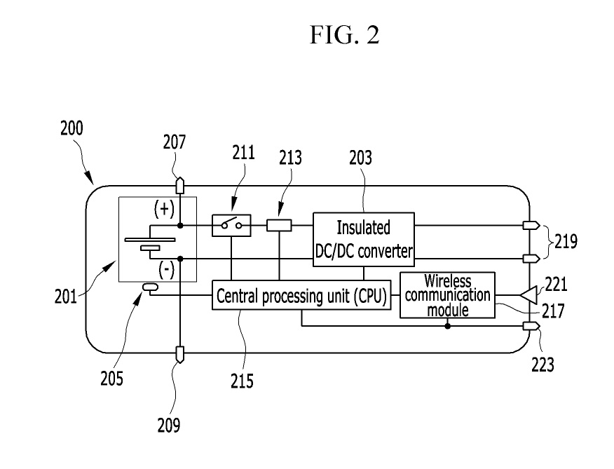

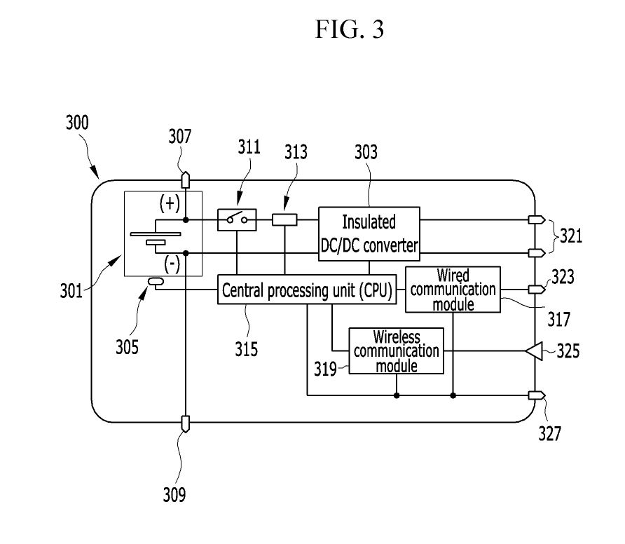

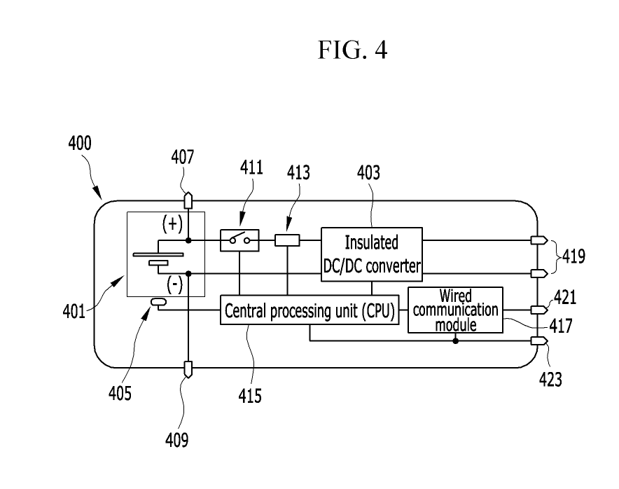

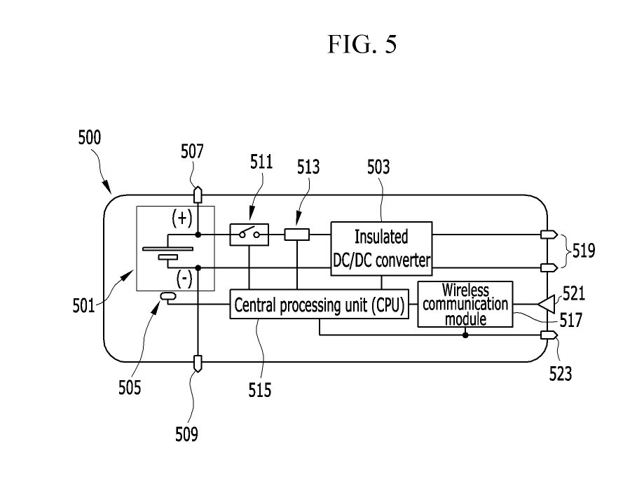

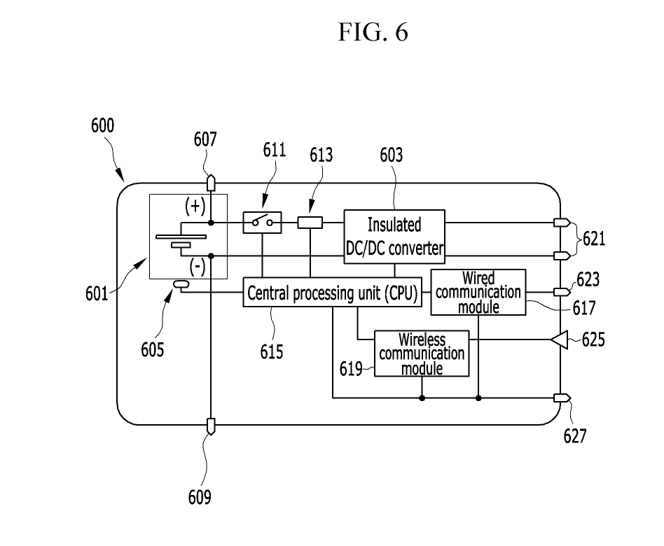

FIG. 1 illustrates a configuration of a DC input wired communication type cell module according to an exemplary embodiment of the present invention, FIG. 2 illustrates a configuration of a DC input wireless communication type cell module according to another exemplary embodiment of the present invention, FIG. 3 illustrates a configuration of a DC input combined communication type cell module according to yet another exemplary embodiment of the present invention, FIG. 4 illustrates a configuration of an AC input wired communication type cell module according to still another exemplary embodiment of the present invention, FIG. 5 illustrates a configuration of an AC input wired communication type cell module according to still yet another exemplary embodiment of the present invention, and FIG. 6 illustrates a configuration of an AC input combined communication type cell module according to still yet another exemplary embodiment of the present invention.

According to the exemplary embodiment of the present invention, in order to implement a battery system without a battery management system (hereinafter, referred to as a ‘BMS’), the cell module embeds a central processing unit (CPU) or a microprocessor.

FIGS. 1 to 6 illustrate configurations of cell modules for each exemplary embodiment. The cell module receives direct current (DC) power or analog current (AC) power from the outside to charge a cell. In addition, the cell is charged or discharged by using a DC/DC converter or an AC/DC converter.

FIGS. 1 to 3 illustrate cell modules receiving the DC power and including the DC/DC converters for each communication mode. In addition, FIGS. 4 to 6 illustrate cell modules receiving the AC power and including the AC/DC converters for each communication mode.

First, referring to FIG. 1, a cell module 100 includes a cell 101, an insulated DC/DC converter 103, a temperature sensor 105, a cell module positive terminal 107, a cell module negative terminal 109, a switch 111, a current sensor 113, a central processing unit (CPU) 115, a wired communication module 117, a DC power terminal 119, a wired communication terminal 121, and a controller power terminal 123.

In this case, the cell module 100 of FIG. 1 wiredly communicates with the BMS or other cell modules through the wired communication module 117 and the wired communication terminal 121.

Next, referring to FIG. 2, a cell module 200 includes a cell 201, an insulated DC/DC converter 203, a temperature sensor 205, a cell module positive terminal 207, a cell module negative terminal 209, a switch 211, a current sensor 213, a CPU 215, a wireless communication module 117, a DC power terminal 219, a wireless antenna 221, and a controller power terminal 223.

Herein, in the cell module 100 of FIG. 1 and the cell module 200 of FIG. 2, configurations or operations thereof are the same as each other. However, since the cell module 100 of FIG. 1 includes the wired communication module 117 and the wired communication terminal 121, and the cell module 200 of FIG. 2 includes the wireless communication module 217 and the wireless antenna 221, the cell modules are different from each other.

The cell module 100 of FIG. 1 wiredly communicates with the BMS or other cell modules through the wired communication module 117 and the wired communication terminal 121, whereas the cell module 200 of FIG. 2 wirelessly communicates with the BMS or other cell modules through wireless communication module 217 and the wireless antenna 221. Accordingly, in the cell module 200 of FIG. 2, the wireless antenna 221 instead of the communication terminal is installed. Other circuit configurations or operations are the same as those of the cell module 100 of FIG. 1.

Next, referring to FIG. 3, a cell module 300 includes a cell 301, an insulated DC/DC converter 303, a temperature sensor 305, a cell module positive terminal 307, a cell module negative terminal 309, a switch 311, a current sensor 313, a CPU 315, a wired communication module 317, a wireless communication module 319, a DC power terminal 321, a wired communication terminal 323, a wireless antenna 325, and a controller power terminal 327.

Herein, the configuration of the operation of the cell module 300 of FIG. 3 is the same as those of the cell module 100 of FIG. 1 and the cell module 200 of FIG. 2. However, the cell modules 100 and 200 of FIGS. 1 and 2 perform only a wired communication mode or a wireless communication mode, respectively, whereas the cell module 300 of FIG. 3 may perform both the wired communication mode and the wireless communication mode. Accordingly, the cell module 300 is different from the cell modules 100 and 200. That is, the cell module 300 of FIG. 3 includes the wired communication module 317, the wireless communication module 319, the wireless antenna 325 and the wired communication terminal 327.

The cell module 300 of FIG. 3 may wiredly communicate with the BMS or external cell modules through the wired communication module 317 and the wired communication terminal 327 or wirelessly communicate with the BMS or the external cell modules through the wireless communication module 319 and the wireless antenna 325.

Next, referring to FIG. 4, a cell module 400 includes a cell 401, an insulated AC/DC converter 403, a temperature sensor 405, a cell module positive terminal 407, a cell module negative terminal 409, a switch 411, a current sensor 413, a CPU 415, a wired communication module 417, an AC power terminal 419, a wired communication terminal 421, and a controller power terminal 423.

Herein, a configuration or an operation of the cell module 400 of FIG. 4 is the same as that of the cell module 100 of FIG. 1. However, there is a difference in that the cell module 100 of FIG. 1 includes the insulated DC/DC converter 103, where the cell module 400 of FIG. 4 uses the insulated AC/DC converter 403.

The cell module 400 of FIG. 4 converts the AC power supplied from the outside to DC through the insulated AC/DC converter 403 to charge the cell 401. Alternatively, the cell module 400 of FIG. 4 discharges the cell 401 to supply the power of the cell 401 to the outside by using a bidirectional insulated AC/DC converter 403. In addition, the cell module 400 of FIG. 4 wiredly communicates with a BMS or other cell modules through the wired communication module 417 and the wired communication terminal 421.

Next, referring to FIG. 5, a cell module 500 includes a cell 501, an insulated AC/DC converter 503, a temperature sensor 505, a cell module positive terminal 507, a cell module negative terminal 509, a switch 511, a current sensor 513, a CPU 515, a wireless communication module 517, an AC power terminal 519, a wireless antenna 521 and a controller power terminal 523.

The configuration or the operation of the cell module 500 of FIG. 5 is the same as that of the cell module 400 of FIG. 4, but there is a difference in that the cell module 400 of FIG. 4 performs the wired communication mode, whereas the cell module 500 of FIG. 5 performs the wireless communication mode. That is, the cell module 400 of FIG. 4 includes the wired communication module 417 and the wired communication terminal 421, whereas the cell module 500 of FIG. 5 includes the wireless communication module 517 and the wireless antenna 521. In addition, the cell module 500 of FIG. 5 wirelessly communicates with a BMS or other cell modules through these configurations 517 and 521.

Next, referring to FIG. 6, a cell module 600 includes a cell 601, an insulated AC/DC converter 603, a temperature sensor 605, a cell module positive terminal 607, a cell module negative terminal 609, a switch 611, a current sensor 613, a CPU 615, a wired communication module 617, a wireless communication module 619, an AC power terminal 621, a wired communication terminal 623, a wireless antenna 625 and a controller power terminal 627.

The configuration or the operation of the cell module 600 of FIG. 6 is the same as those of the cell module 400 of FIG. 4 and the cell module 500 of FIG. 5. However, there is a difference in that the cell modules 400 and 500 of FIGS. 4 and 5 perform only a wired communication mode or a wireless communication mode, respectively, whereas the cell module 600 of FIG. 6 may perform both the wired communication mode and the wireless communication mode. That is, the cell module 600 of FIG. 6 includes all of the wired communication module 617, the wireless communication module 619, the wired communication terminal 623, and the wireless antenna 625. In addition, the cell module 600 of FIG. 6 may wiredly communicate with a BMS or external cell modules through the wired communication module 617 and the wired communication terminal 623 or wirelessly communicate with the BMS or the external cell modules through the wireless communication module 619 and the wireless antenna 625.

Then, respective constituent elements of FIGS. 1, 2, 3, 4, 5, and 6 will be described below.

The cells 101, 201, 301, 401, 501, and 601 are included in the cell modules 100, 200, 300, 400, 500, and 600, respectively. The cells 101, 201, 301, 401, 501, and 601 are devices in which cell current is charged and recharged and used when being discharged.

The cells 101, 201, 301, 401, 501, and 601 may be directly charged by receiving DC current from an external charger (not illustrated) and separately charged by receiving current suitable for states of the cells 101, 201, 301, 401, 501, and 601 from an internal charger (not illustrated).

The cells 101, 201, 301, 401, 501, and 601 are connected with the cell module positive terminals 107, 207, 307, 407, 507, and 607 and the cell module negative terminals 109, 209, 309, 409, 509, and 609, respectively. The cell module positive terminals 107, 207, 307, 407, 507, and 607 and the cell module negative terminals 109, 209, 309, 409, 509, and 609 may be used to withdraw the power to the outside or charge the cells 101, 201, 301, 401, 501, and 601.

The insulated DC/DC converters 103, 203, and 303 or the insulated AC/DC converters 403, 503, and 603 are connected with the DC power terminal 119, 219, and 321 and charge the cells 101, 201, 301, 401, 501, and 601 by the DC power supplied from the outside through the DC power terminals 119, 219, and 321

The insulated DC/DC converters 103, 203, and 303 or the insulated AC/DC converters 403, 503, and 603 may unidirectionally operate or bidirectionally operate.

The temperature sensors 105, 205, 305, 405, 505, and 605 operate temperatures of the cells 101, 201, 301, 401, 501, and 601 in a reference range. The temperature sensors 105, 205, 305, 405, 505, and 605 are connected with the CPUs 115, 215, 315, 415, 515, and 615. The temperature sensors 105, 205, 305, 405, 505, and 605 measure the temperatures of the cells 101, 201, 301, 401, 501, and 601 to transfer the temperatures to the CPUs 115, 215, 315, 415, 515, and 615. The temperature sensors 105, 205, 305, 405, 505, and 605 may be negative temperature coefficient (NTC) temperature sensors as devices in which electric resistance is related with the temperature.

The switches 111, 211, 311, 411, 511, and 611 are positioned between the cells 101, 201, 301, 401, 501, and 601 and the insulated DC/DC converters 103, 203, and 303 or the insulated AC/DC converters 403, 503, and 603 to connect or interrupt the cells 101, 201, 301, 401, 501, and 601 and the insulated DC/DC converters 103, 203, and 303 or the insulated AC/DC converters 403, 503, and 603.

The switches 111, 211, 311, 411, 511, and 611 are connected with the CPUs 115, 215, 315, 415, 515, and 615. The switches 111, 211, 311, 411, 511, and 611 are opened or closed according to a control of the BMS installed in the CPUs 115, 215, 315, 415, 515, and 615 or the BMS mounted on an external device connected by wired communication or wireless communication.

The switches 111, 211, 311, 411, 511, and 611 may be a field effective transistor, an element, a relay, a magnetic switch, and the like.

The current sensors 113, 213, 313, 413, 513, and 613 are connected with the insulated DC/DC converters 103, 203, and 303 or the insulated AC/DC converters 403, 503, and 603, the switches 111, 211, 311, 411, 511, and 611, and the CPUs 115, 215, 315, 415, 515, and 615.

The current sensors 113, 213, 313, 413, 513, and 613 detect current which is supplied from the insulated DC/DC converters 103, 203, and 303 or the insulated AC/DC converters 403, 503, and 603 to the cells 101, 201, 301, 401, 501, and 601 or current which is supplied to the insulated DC/DC converters 103, 203, and 303 or the insulated AC/DC converters 403, 503, and 603 from the cells 101, 201, 301, 401, 501, and 601. In addition, the detected current is output to the CPUs 115, 215, 315, 415, 515, and 615.

The cell modules 100, 200, 300, 400, 500, and 600 detect over-discharging, over-charging, or a case of deviating from a safety temperature of the cells 101, 201, 301, 401, 501, and 601 through the current sensors 113, 213, 313, 413, 513, and 613. That is, the BMS may control the switches 111, 211, 311, 411, 511, and 611 to protect the cell modules 100, 200, 300, 400, 500, and 600, when current flowing from external power (not illustrated) to the cells 101, 201, 301, 401, 501, and 601 or current from the cells 101, 201, 301, 401, 501, and 601 to external load (not illustrated) deviates from the safety temperature.

The current sensors 113, 213, 313, 413, 513, and 613 may be implemented by hall sensors, shunt resistance, and the like.

The CPUs 115, 215, 315, 415, 515, and 615 are connected with the insulated DC/DC converters 103, 203, and 303 or the insulated AC/DC converters 403, 503, and 603, the temperature sensors 105, 205, 305, 405, 505, and 605, the switches 111, 211, 311, 411, 511, and 611, and the current sensors 113, 213, 313, 413, 513, and 613.

The CPUs 115, 215, 315, 415, 515, and 615 controls the insulated DC/DC converters 103, 203, and 303 or the insulated AC/DC converters 403, 503, and 603 to charge or discharge the cells 101, 201, 301, 401, 501, and 601.

Referring to FIGS. 1 and 4, the CPUs 115 and 415 are connected with the wired communication modules 117 and 417 which are connected with the wired communication terminals 121 and 421. The CPUs 115 and 415 receive a command of the BMS through the wired communication module 117 and 417 and the wired communication terminal 121 and 421 to manage the cell modules 100 and 400. The CPUs 115 and 415 charge the cells 101 and 401 according to a control of the BMS.

The CPUs 115 and 415 may output information regarding cell voltage, current, temperatures, and the like which are collected in the cell modules 100 and 400 to the BMS or the cell module mounted with the BMS through the wired communication modules 117 and 417 and the wired communication terminals 121 and 421.

Referring to FIGS. 2 and 5, the CPUs 215 and 515 are connected with the wireless communication modules 217 and 517 which are connected with the wireless antennas 221 and 521. The CPUs 215 and 515 receive a command of the BMS through the wireless communication modules 217 and 517 and the wireless antennas 221 and 521 to manage the cell modules 200 and 500. The CPUs 215 and 515 charge the cells 201 and 501 according to a control of the BMS.

The CPUs 215 and 515 may output information regarding cell voltage, current, temperatures, and the like which are collected in the cell modules 200 and 500 to the BMS or the cell module mounted with the BMS through the wireless communication modules 217 and 517 and the wireless antennas 221 and 521.

Referring to FIGS. 3 and 6, the CPUs 315 and 615 may output information regarding cell voltage, current, temperatures, and the like which are collected in the cell modules 300 and 600 to the BMS or the cell module mounted with the BMS by the wired communication mode as illustrated in FIGS. 1 and 4 or to the BMS or the cell module mounted with the BMS by the wireless communication mode as illustrated in FIGS. 2 and 5.

In this case, the power of the CPUs 115, 215, 315, 415, 515, and 615, the wired communication modules 117 and 317, and the wireless communication modules 217 and 319 is supplied through the controller power terminals 123, 223, 327, 423, 523, and 627 from the outside.

The CPUs 115, 215, 315, 415, 515, and 615 operate only when the power is present and stop all operations when the power is not supplied from the outside. As such, when the operations are stopped, the switches 111, 211, 311, 411, 511, and 611 are opened to be interrupted from the cells 101, 201, 301, 401, 501, and 601, and thus the power of the cells 101, 201, 301, 401, 501, and 601 is not consumed.

The wired communication modules 117, 317, 417, and 617 are connected with the CPUs 115, 315, 415, and 615, the wired communication terminals 121, 323, 421, and 623 and the controller power terminals 123, 327, 423, and 627.

The wired communication modules 117, 317, 417, and 617 may wiredly communicate with external equipment or other cell modules connected through the wired communication terminals 121, 323, 421, and 623. Herein, the wired communication mode may use a control area network (CAN), RS485, RS422, RS232, Ethernet, and the like, but is not limited to these communication modes.

The wireless communication modules 217, 319, 517, and 619 are connected with the CPUs 215, 315, 515, and 615, the wireless antennas 221, 325, 521, and 625, and the controller power terminals 223, 327, 523, and 627. The wireless communication modules 217, 319, 517, and 619 may wirelessly communicate with external equipment or other cell modules connected through the wireless antennas 221, 325, 521, and 625. Herein, the wireless communication mode may use Bluetooth, ZigBee, Z-Wave, and the like. However, the operations of the cell modules 200 and 300 are regardless of the communication mode of the used wireless communication modules 217, 319, 517, and 619.

The DC power terminals 119, 219, and 321 are terminals for charging or discharging the cells 101, 201, and 301. The power that charges or discharges the cells 101, 201, and 301 is exchanged with external equipment (not illustrated) through the DC power terminals 119, 219, and 321.

The AC power terminals 419, 519, and 621 are terminals for charging or discharging the cells 401, 501, and 601. The power that charges or discharges the cells 401, 501, and 601 is exchanged with external equipment (not illustrated) through the AC power terminals 419, 519, and 621.

The controller power terminals 123, 223, 327, 423, 523, and 627 are terminals for supplying the power to the CPUs 115, 215, 315, 415, 515, and 615 from the outside.

The wired communication modules 117, 317, 417, and 617, the DC power terminals 119, 219, and 321, the wired communication terminals 121, 323, 421, and 623, the AC power terminal 419, 519, and 621, and the controller power terminals 123, 223, 327, 423, 523, and 627 use insulated types. As such, even though the cell modules 100, 200, 300, 400, 500, and 600 are connected to each other in series or in parallel at the outside, the insulation problem does not occur.

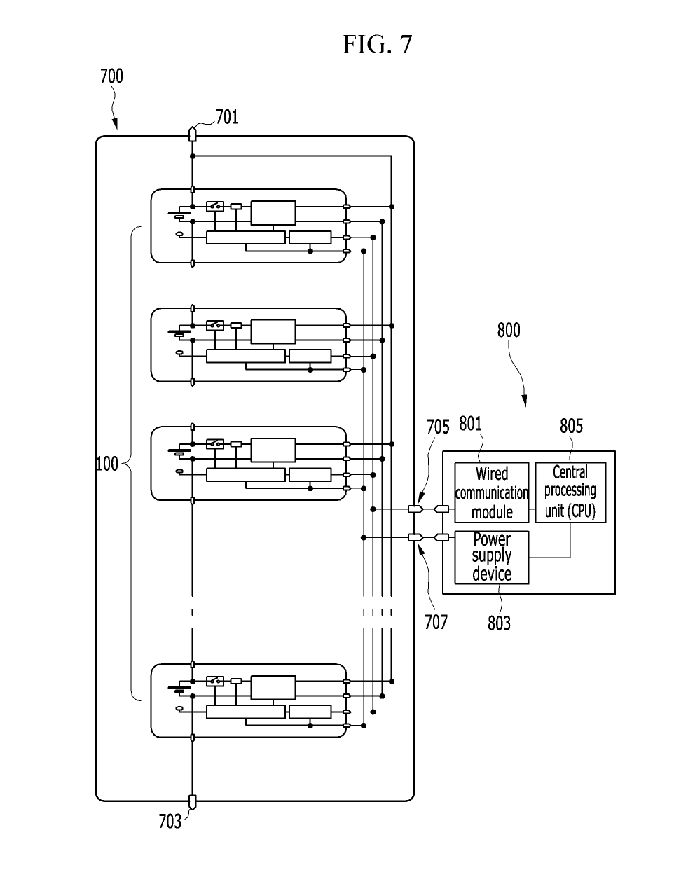

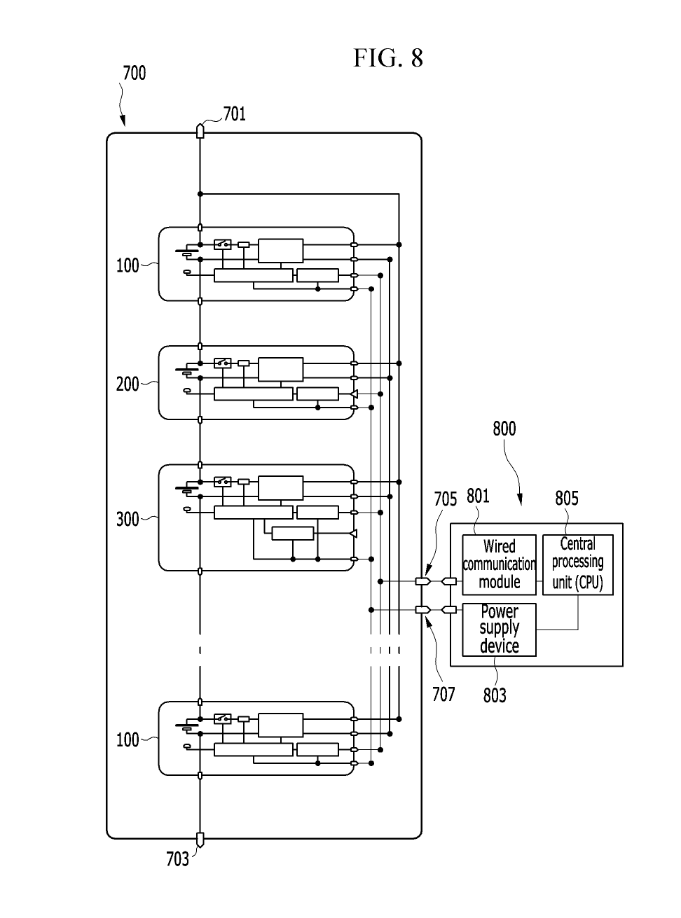

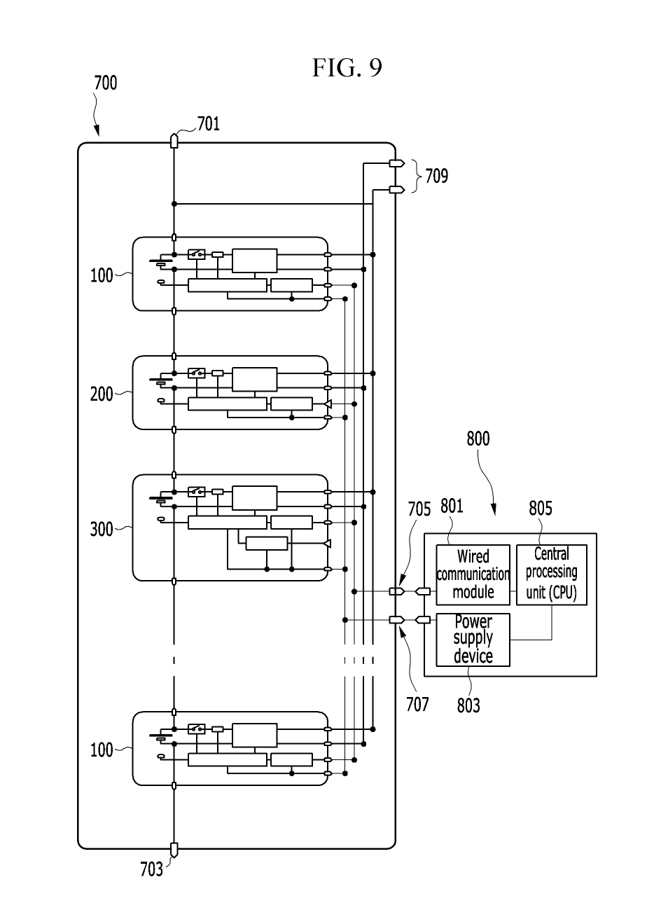

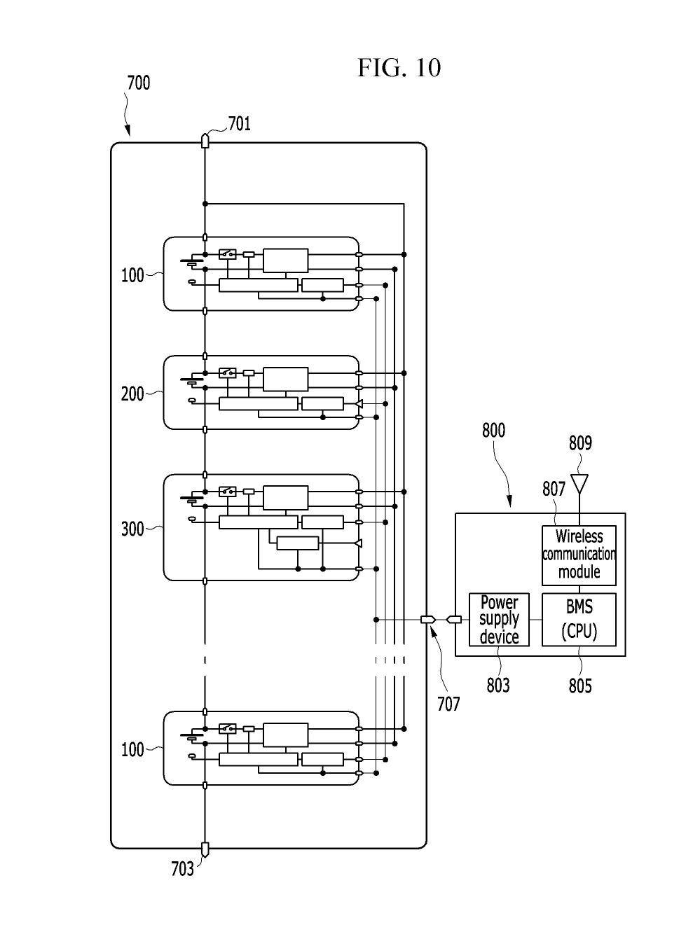

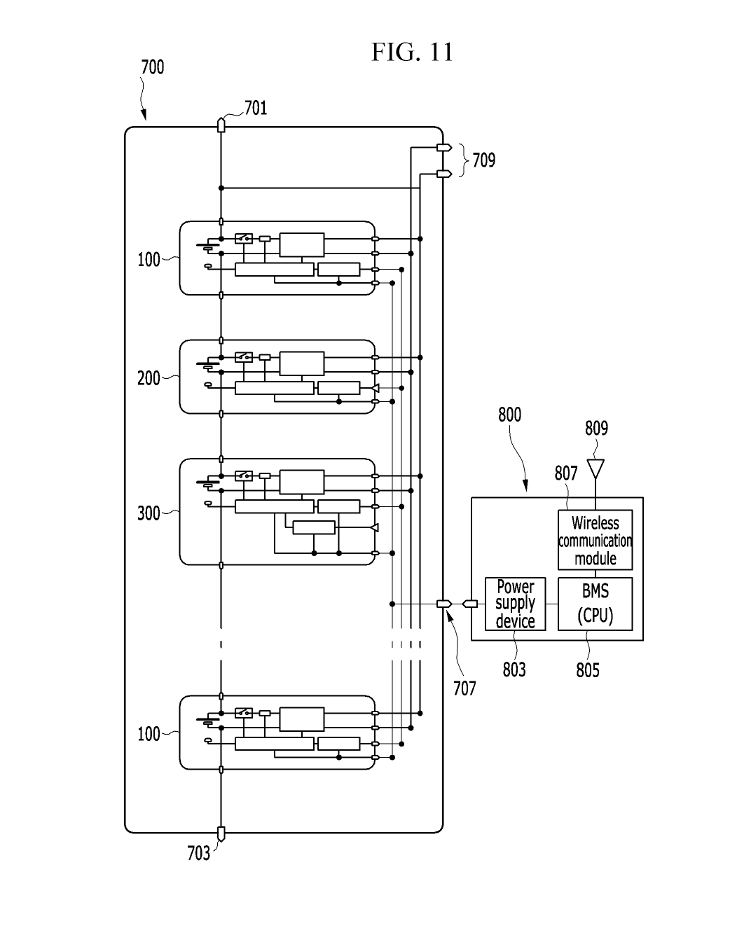

FIG. 7 illustrates a connection configuration between a battery and a battery control system according to an exemplary embodiment of the present invention, FIG. 8 illustrates a connection configuration between a battery and a battery control system according to another exemplary embodiment of the present invention, FIG. 9 illustrates a connection configuration between a battery and a battery control system according to yet another exemplary embodiment of the present invention, FIG. 10 illustrates a connection configuration between a battery and a battery control system according to still another exemplary embodiment of the present invention, and FIG. 11 illustrates a connection configuration between a battery and a battery control system according to still yet another exemplary embodiment of the present invention.

A battery 700 of FIGS. 7 to 11 may be a battery pack form in which a plurality (N) of cell modules are connected to each other in any one form of in series, in parallel, and a combination form thereof to be stacked. As such, each of the stacked cell modules is connected with external equipment 800.

First, referring to FIG. 7, an example configuring a battery system by using the DC input wired communication type cell module 100 of FIG. 1 is illustrated. That is, the battery 700 includes a plurality (N) of cell modules 100, a battery positive terminal 701, a battery negative terminal 703, a communication connector 705 and a power connector 707.

In this case, the N cell modules 100 are connected to each other in series to configure the battery 700, but the N cell modules 100 may be connected to each other in parallel and connected to each other in a combination of series and parallel.

The DC power terminals 119 of the plurality (N) of cell modules 100 are connected to each other, and each DC power terminal 119 is connected with the battery positive terminal 701 and the battery negative terminal 703.

In this case, the battery positive terminal 703 is connected with the cell module positive terminal 105 of cell module 1, the battery negative terminal 705 is connected with the cell module negative terminal 107 of cell module N, and the cell module positive terminal 105 and the cell module negative terminal 107 are connected to each other between the cell module 1, . . . , the cell module N. That is, the cell module negative terminal 107 of the cell module 1 is connected with the cell module positive terminal 105 of the cell module 2. Accordingly, the battery voltage is supplied to the cell 101 through the insulated DC/DC converter 103 of the cell module 100. The insulated DC/DC converter 103 converts battery voltage to voltage suitable to charge the cell 101.

The CPU 115 of the cell module 100 controls the insulated DC/DC converter 103 by receiving the command of the BMS to charge or discharge the battery 700.

Further, the wired communication terminals 121 of the plurality (N) of cell modules 100 are connected to each other and also connected with the communication connector 707.

Further, the controller power terminals 123 of the plurality (N) of cell modules 100 are connected to each other and also connected with the power connector 709.

As such, all of the cell modules 100 in the battery 700 are connected to the wired communication terminal 121 and the wired communication terminal 121 is connected with a communication module 801 of external equipment 800 through the communication connector 705.

The controller power terminals 123 of the cell modules 100 are connected to each other to be connected with a power supply unit 803 of the external equipment 800 through the power connector 709. Accordingly, when the BMS discharges the cell 101 of the cell module 100, the power of the cell 101 is supplied to the battery 700.

When failure in one or more of the cell modules 100 configuring the battery 700 occurs, the BMS controls the insulated DC/DC converter 103 of the normal cell modules 100 to discharge the cells of the normal cell modules. Then, the battery 700 may obtain an output from the remaining cells other than the cells having the failure.

Since BMS software is downloaded to the external equipment 800, there is no separate hardware BMS in the battery 700 unlike the related art. As such, the battery system according to the exemplary embodiment of the present invention is constituted by only the battery without the BMS hardware.

As such, when the BMS software is downloaded to a CPU 805 of the external equipment 800 and executed, the cell modules 100 in the battery 700 operates by receiving the command of the CPU 805 of the external equipment 800.

In this case, the external equipment 800 may be a computer, a programmable logic controller (PLC) of the external equipment, external BMS hardware, an embedded personal computer embedded in the equipment, or a smart phone, but is not limited thereto and corresponds to any one of equipment capable of downloading and executing the BMS software.

Further, the BMS software may be downloaded to the CPU 115 of one cell module 100 among the plurality (N) of cell modules 100 without the external equipment 800 and executed. In this case, one cell module 100 in which the BMS software is executed controls the remaining cell modules 100. In this case, the communication between the cell modules 100 is performed by wired communication.

As such, when the BMS is implemented in a BMS software form without mounting a separate BMS hardware when the battery 700 is supplied, price competitiveness of the battery product is better, system integration is easy, and the function of the BMS may be designed to fit user's needs.

Further, FIG. 8 is implemented by the battery 700 and the external equipment 800 like FIG. 7, but the cell module configuring the battery 700 is used by combining two or more cell modules adopted from the cell modules of FIGS. 1, 2, and 3. In this case, one cell module of FIG. 1 or FIG. 3 which enables wired communication is necessarily included.

For example, the cell module 1 may be the cell module of FIG. 1, the cell module 2 may be the cell module of FIG. 2, and the cell module N may be the cell module of FIG. 3. Alternatively, the cell module 1 is the cell module of FIG. 1 and the cell modules 2, . . . , N may be implemented by various methods as the cell module of FIG. 2 or 3.

In this case, the cell modules in the battery 700 wiredly or wirelessly communicate with each other and only one cell module of the cell modules wiredly communicates with the external equipment 800.

Further, FIG. 9 is implemented by the battery 700 and the external equipment 800 like FIG. 8, but the cell module configuring the battery 700 may be used by combining one method or two or more methods of FIGS. 1, 2, 3, 4, 5, and 6.

In this case, the battery 700 further includes an external power terminal 709 unlike FIG. 8. In addition, the DC power terminals 119, 219, and 321 connected with the insulated DC/DC converters 103, 203, and 303 or the AC power terminals 419, 519, and 621 connected with the insulated AC/DC converters 403, 503, and 603 are connected with the external power terminal 709 other than the battery positive terminal and the battery negative terminal 701 and 703.

Accordingly, in FIGS. 7 and 8, an input voltage range of the insulated DC/DC converters 103, 203, and 303 is determined by the battery voltage, whereas in FIG. 9, the input voltage range of the insulated DC/DC converters 103, 203, and 303 or the insulated AC/DC converters 403, 503, and 603 may be freely selected by using an external power supply device.

FIG. 10 is implemented the same as FIG. 8, but the battery 700 of FIG. 8 wiredly communicates with the external equipment 800, whereas the battery 700 of FIG. 10 wirelessly communicates with the external equipment 800. Accordingly, the cell module of FIG. 10 is implemented by one or more of cell modules of FIGS. 1, 2, 3, 4, 5, and 6, but among them, one cell module of FIGS. 2, 3, 5, and 6 which enable the wireless communication mode is necessarily included. In addition, the respective cell modules are wiredly or wirelessly connected to each other.

FIG. 11 is implemented the same as FIG. 9, but the battery 700 of FIG. 9 wiredly communicates with the external equipment 800, whereas the battery 700 of FIG. 11 wirelessly communicates with the external equipment 800. Accordingly, the cell module of FIG. 10 is implemented by one or more of cell modules of FIGS. 1, 2, 3, 4, 5, and 6, but among them, one cell module of FIGS. 2, 3, 5, and 6 which enable the wireless communication mode is necessarily included. In addition, the respective cell modules are wiredly or wirelessly connected to each other.

As described above, when the battery system is configured like FIGS. 7, 8, 9, 10, and 11, the BMS bidirectionally controls the insulated DC/DC converters or the insulated AC/DC converters for each cell module, respectively to charge and discharge the cells of the cell modules. The method may be used for cell balancing.

Particularly, in the battery system of FIGS. 9 and 11, the BMS controls the insulated DC/DC converters or the insulated AC/DC converters of the cell modules to charge the cell of the cell module by required figures and may manage the battery 700 to supply the DC output or the AC output of the desired voltage through the external power terminal 709 of the battery.

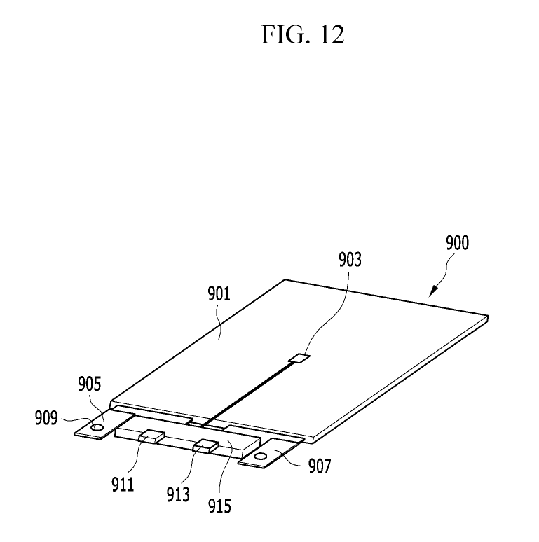

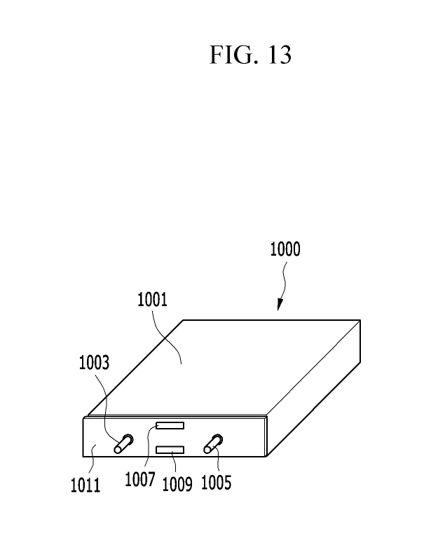

The cell module forms a basic unit capable of supplying the power. In addition, the cell modules 1 are stacked and combined in assembled and dissembled states and called a cell module assembly. The cell of the cell module may have a plate shape as illustrated in FIG. 12 or a polygonal bar shape as illustrated in FIG. 13, but is not limited to the example and various examples are possible.

FIG. 12 illustrates a cell module according to an exemplary embodiment of the present invention. In this case, the cell module may include at least one configuration of FIGS. 1 to 6.

Referring to FIG. 12, as an example in which the cell module is directly assembled without a cell tray, in a cell module 900, a temperature sensor 903 is disposed on the top of a battery cell 901 having a plate shape. Herein, the shape of the cell may be various shapes according to a type of cell and a capacity of the cell.

The cell module positive terminal 905 and the module negative terminal 907 are disposed on one side of the battery cell 901, and a cell module output terminal hole 909 is formed in each terminal 905 or 907. In addition, the communication terminal and the communication connector 911 and the power terminal and the power connector 913 are coupled with each other, and a printed circuit board (PCB) 915 with a circuit unit for charge and discharge control is coupled to one side of the battery cell 901.

Herein, the circuit unit includes a control board which implements the CPU, the insulated DC/DC converter or insulated AC/DC converter, and the wired communication module or wireless communication module.

FIGS. 13 to 15 illustrate cell modules according to another exemplary embodiment of the present invention, and in this case, the cell module may include at least one configuration of FIGS. 1 to 6.

Referring to FIGS. 13 to 15, as an example in which the cell module is directly assembled without a cell tray, a cell module 1000 includes a battery cell 1001 having a hexahedral shape. Herein, the shape of the cell may be various shapes according to a type of cell and a capacity of the cell.

On one side of the cell 1001, a cell module positive terminal 1003 and a cell module negative terminal 1005 are disposed.

On one side of the cell 1001, a communication terminal and a communication connector 1007 and a power terminal and a power connector 1009 are coupled to each other, and a printed circuit board (PCB) 1011 with a circuit unit for charge and discharge control is coupled to one side of the cell 1001. Herein, the circuit unit includes a control board which implements the CPU, the insulated DC/DC converter or insulated AC/DC converter, and the wired communication module or wireless communication module.

In this case, referring to FIG. 14, the printed circuit board 1011 may be disposed on another side without the cell module positive terminal 1003 and the cell module negative terminal 1005, for example, a right side.

Further, referring to FIG. 15, the printed circuit board 1011 may be disposed on another side without the cell module positive terminal 1003 and the cell module negative terminal 1005, for example, a rear side.

FIGS. 13 to 15 are the same structure as FIG. 12, but there is a difference from FIG. 12 in that FIG. 12 uses a pouch type cell 901, whereas FIGS. 13 to 15 use the square cell 1001.

Further, in FIG. 12, the temperature sensor 903 is shown at the outside, but in FIGS. 13 to 15, the temperature sensor is present between the battery cell 1001 and the PCB 1011 and not shown at the outside. In addition, the cell module positive terminal 905 and the cell module negative terminal 907 in FIG. 12 have plate shapes or the cell module positive terminal 1003 and the cell module negative terminal 1005 in FIGS. 13 to 15 have rod or cylindrical shapes. The cell module positive terminals and the cell module negative terminals are different from each other due to the cell structure.

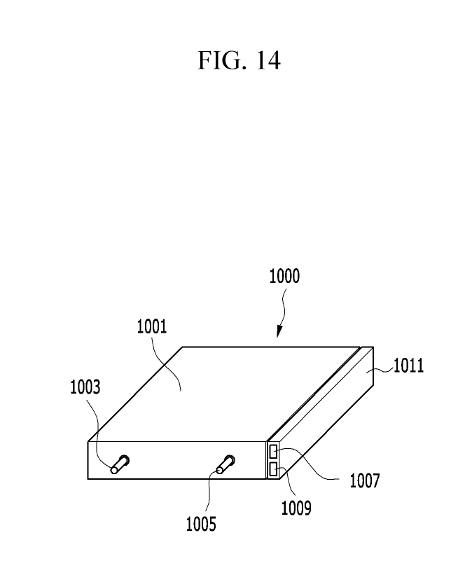

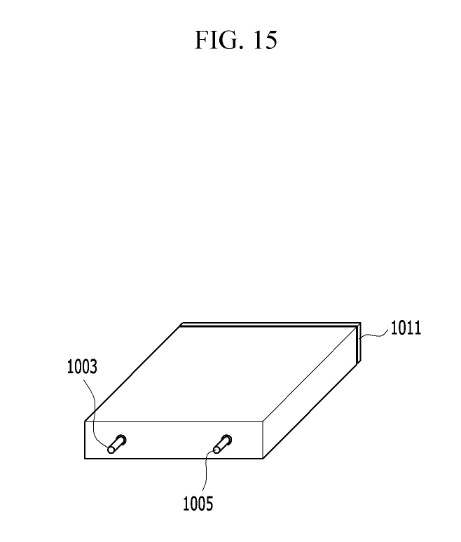

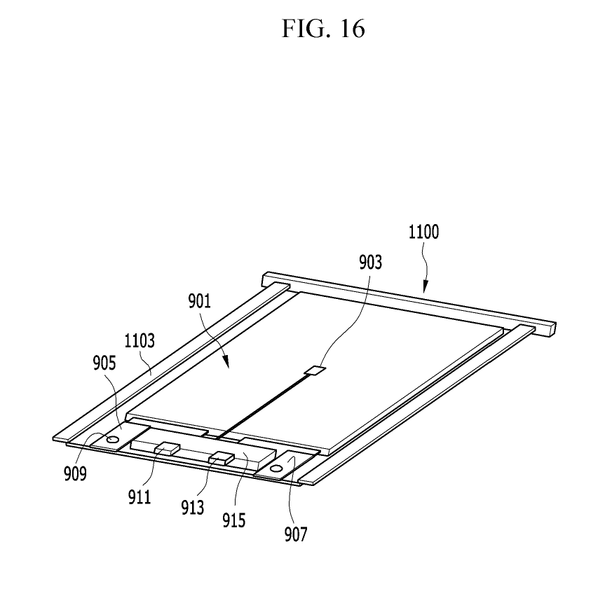

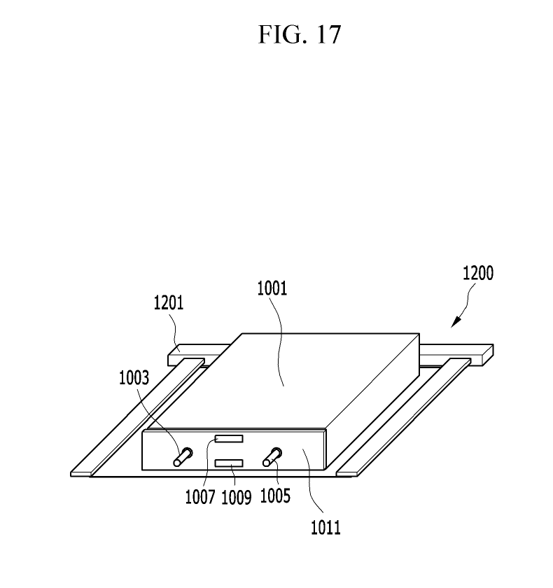

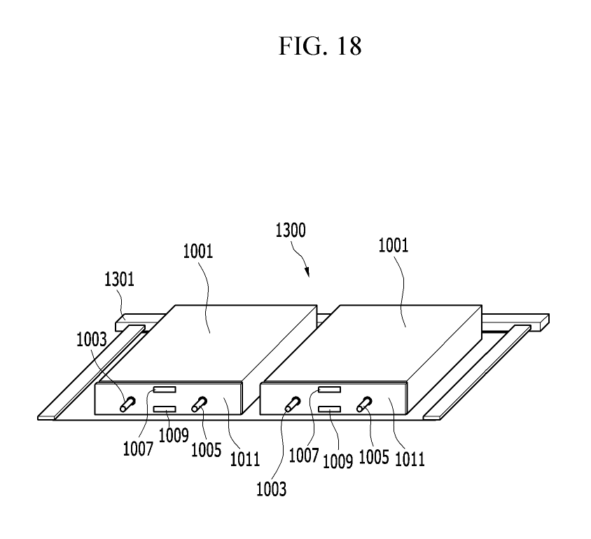

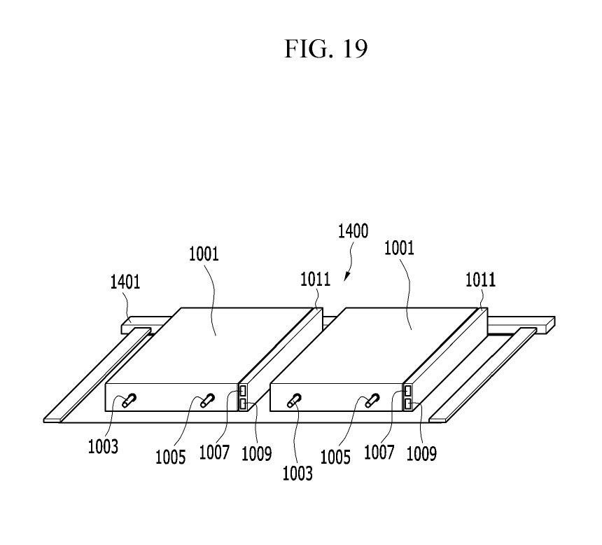

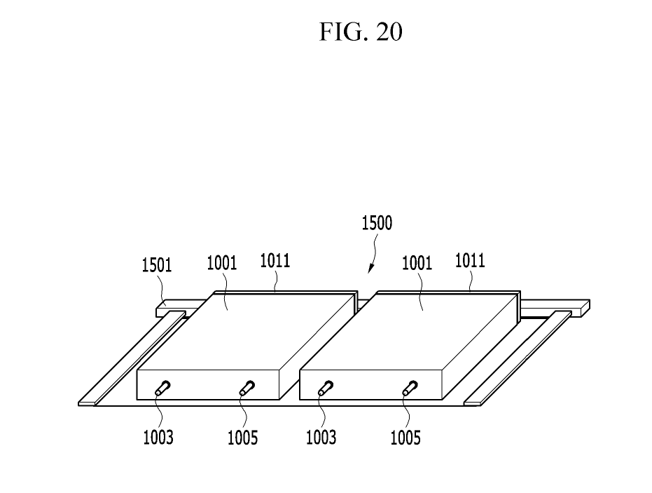

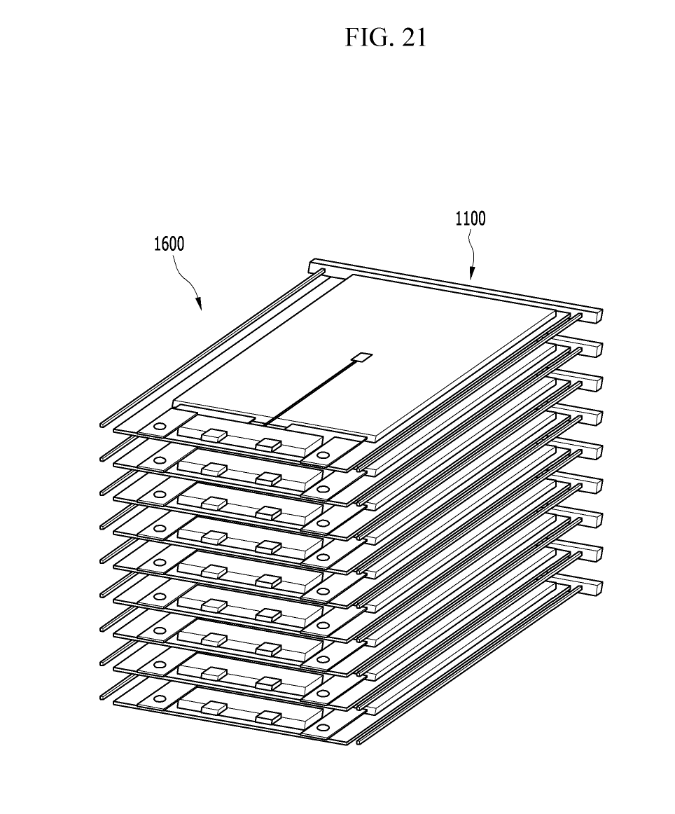

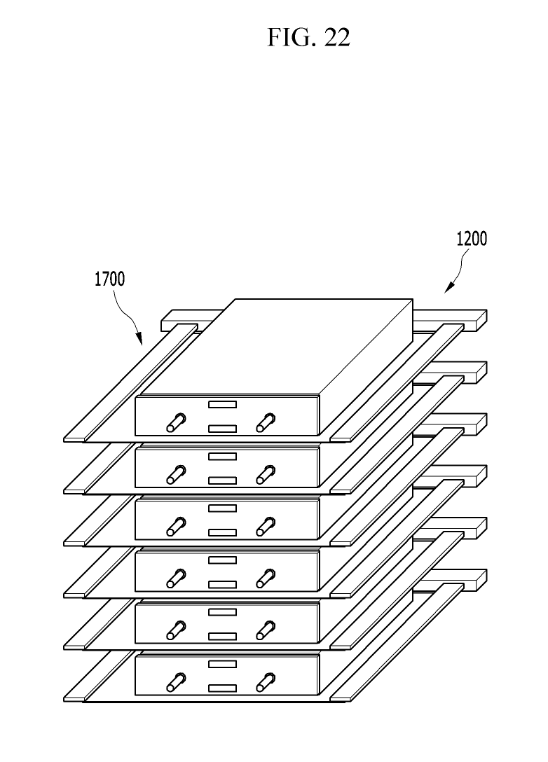

FIG. 16 illustrates a cell module assembly according to an exemplary embodiment of the present invention, FIG. 17 illustrates a cell module assembly according to another exemplary embodiment of the present invention, FIG. 18 illustrates a cell module assembly according to yet another exemplary embodiment of the present invention, FIG. 19 illustrates a cell module assembly according to still another exemplary embodiment of the present invention, FIG. 20 illustrates a cell module assembly according to another exemplary embodiment of the present invention, FIG. 21 illustrates stacked cell module assemblies according to an exemplary embodiment of the present invention, FIG. 22 illustrates stacked cell module assemblies according to another exemplary embodiment of the present invention, FIG. 23 illustrates stacked cell module assemblies according to yet another exemplary embodiment of the present invention, and FIG. 24 illustrates stacked cell module assemblies according to still another exemplary embodiment of the present invention.

Referring to FIG. 16, a cell module assembly 1100 disposed in a flat tray 1101 which can insert the cell module 900 of FIG. 12 in a drawer form is illustrated.

Referring to FIG. 17, a cell module assembly 1200 disposed in a flat tray 1201 which can insert the cell module 1000 of FIG. 13 in a drawer form is illustrated.

Referring to FIGS. 18 to 20, a plurality of cell modules may be disposed in one tray. For example, two cell modules are disposed in one tray to implement the cell module assembly. That is, referring to FIG. 18, a cell module assembly 1300 disposed in a flat tray 1301 which can insert the cell module 1000 of FIG. 13 in a form of two drawers is illustrated.

Further, referring to FIG. 19, a cell module assembly 1400 disposed in a flat tray 1401 which can insert the cell module 1000 of FIG. 14 in a form of two drawers is illustrated.

Further, referring to FIG. 20, a cell module assembly 1500 disposed in a flat tray 1501 which can insert the cell module 1000 of FIG. 15 in a form of two drawers is illustrated.

Referring to FIG. 21, a cell module assembly 1600 stacking the cell module assemblies 1100 of FIG. 16 is illustrated.

Referring to FIG. 22, a cell module assembly 1700 stacking the cell module assemblies 1200 of FIG. 17 is illustrated.

Referring to FIG. 23, a cell module assembly 1800 stacking the cell module assemblies 1500 of FIG. 20 is illustrated.

Referring to FIG. 24, a cell module assembly 1900 stacking the cell module assemblies 1600 of FIG. 21 in a drawer form is illustrated.

Further, although not illustrated, the cell module assemblies 1700 and 1800 of FIGS. 22 and 23 may be the cell module assembly 1900 stacked in the drawer form.

Further, the cell module assemblies 1600, 1700, and 1800 illustrated in FIGS. 21, 22, and 23 may be selectively stacked in a form of two or more drawers.

In this case, two or more different cell modules may be stacked in a drawer form without a tray. When the method is used, the maintenance of the cell modules is convenient.

The exemplary embodiments of the present invention described above are not implemented only through the device and the method, but may also be implemented through a program which implements functions corresponding to the configurations of the exemplary embodiment of the present invention or a recoding medium on which the program is recorded.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims

What is claimed is:

1. A battery pack, comprising:
at least one cell module; and
a communication connector connected with the at least one cell module to wiredly communicate with external equipment,
wherein the at least one cell module
is connected with the communication connector to control charge and discharge of the cell according to a control command received from the external equipment, and
the external equipment
is installed with an external hardware device in which a battery management system transmitting the control command is implemented or software implementing the battery management system.

2. The battery pack of claim 1, wherein:
the at least one cell module includes a wired communication type cell module
which further includes a wired communication terminal and a wired communication module which are wiredly connected with the communication connector to receive the control command, and
a CPU that controls the charging and the discharging according to the control command received through the wired communication terminal and the wired communication module,
in which the cell modules are connected to each other through the wired communication terminal among the plurality of wired communication type cell modules.

3. The battery pack of claim 2, wherein:
the at least one cell module includes
a wireless communication type cell module including a wireless antenna and a wireless communication module, and
a CPU that controls charging and discharging of the cell according to a control command received through the wireless antenna and the wireless communication module, and
a combined communication type cell module including a wired communication terminal and a wired communication module which are wiredly connected with the communication connector and the wired communication type cell module,
a wireless antenna that wirelessly communicates with the wireless communication type cell module and a wireless communication module connected with the wireless antenna, and
a CPU that receives a control command from the external equipment through the wired communication terminal and the wired communication module, controls charging and discharging of the cell according to the control command, and transfers the control command to the wireless communication type cell module connected through the wireless antenna.

4. The battery pack of claim 3, further comprising:
a battery positive terminal and a battery negative terminal; and
a power connector for supplying power from the external equipment,
wherein the wired communication type cell module, the wireless communication type cell module, and the combined communication type cell module further include
a cell including a cell module positive terminal connected with the battery positive terminal and a cell module negative terminal connected with the battery negative terminal,
a DC power terminal connected with the battery positive terminal and the battery negative terminal to receive battery voltage, and
a DC-DC converter positioned between the cell and the DC power terminal and charging DC power received from the DC power terminal in the cell.

5. The battery pack of claim 4, wherein:
the wired communication type cell module further includes
a controller power terminal connected with the power connector to supply the power received from the external equipment to the CPU and the wired communication module, and
the wired communication terminal, the controller power terminal, and the DC power terminal are connected to each other among a plurality of first cell modules.

6. The battery pack of claim 5, wherein:
the wireless communication type cell module further includes
a controller power terminal connected with the power connector to supply the power received from the external equipment to the CPU and the wireless communication module,
the combined communication type cell module further includes
a controller power terminal connected with the power connector to supply the power received from the external equipment to the CPU, the wireless communication module and the wired communication module,
the wired communication terminal, the controller power terminal and the DC power terminal are connected with each other between the combined communication type cell module and at least one wired communication type cell module,
the wireless communication terminal, the controller power terminal and the DC power terminal are connected with each other between the combined communication type cell module and at least one wireless communication type cell module, and
the controller power terminal and the DC power terminal are connected with each other between the at least one wired communication type cell module and the at least one wireless communication type cell module.

7. The battery pack of claim 3, further comprising:
a battery positive terminal and a battery negative terminal;
a power connector for supplying the power from the external equipment; and
an external power terminal,
wherein the wired communication type cell module, the wireless communication type cell module, and the combined communication type cell module further include
a cell including a cell module positive terminal connected with the battery positive terminal and a cell module negative terminal connected with the battery negative terminal,
an AC power terminal connected with the external power terminal to receive external AC voltage, and
an AC-DC converter positioned between the cell and the AC power terminal and converting AC power received from the AC power terminal to DC power to charge the cell.

8. The battery pack of claim 7, wherein:
the wired communication type cell module further includes
a controller power terminal connected with the power connector to supply the power received from the external equipment to the CPU and the wired communication module, and
the wireless communication type cell module further includes
a controller power terminal connected with the power connector to supply the power received from the external equipment to the CPU and the wireless communication module,
the combined communication type cell module further includes
a controller power terminal connected with the power connector to supply the power received from the external equipment to the CPU, the wireless communication module and the wired communication module,
the wired communication terminal, the controller power terminal and the AC power terminal are connected with each other between the combined communication type cell module and at least one wired communication type cell module,
the wireless communication terminal, the controller power terminal and the AC power terminal are connected with each other between the combined communication type cell module and at least one wireless communication type cell module, and
the controller power terminal and the AC power terminal are connected with each other between the at least one wired communication type cell module and the at least one wireless communication type cell module.

9. A battery pack, comprising:
at least one cell module,
wherein the at least one cell module includes
a wired communication type cell module including a CPU controlling charging and discharging of a cell according to a control command received through wired communication,
a wireless communication type cell module including a CPU controlling charging and discharging of the cell according to the control command received from the external equipment through wireless communication, and
a combined communication type cell module that controls the charging and discharging of the cell according to the control command received from the external equipment through wireless communication and transfers the control command to the wired communication type cell module through the wired communication, and
the external equipment
is installed with an external hardware device in which a battery management system transmitting the control command is implemented or software implementing the battery management system.

10. The battery pack of claim 9, further comprising:
a battery positive terminal and a battery negative terminal; and
a power connector for supplying power from the external equipment,
wherein the wired communication type cell module, the wireless communication type cell module, and the combined communication type cell module
charge the cell by battery voltage received from the battery positive terminal and the battery negative terminal, and
supply the power of the CPU as the power received from the power connector.

11. The battery pack of claim 10, wherein:
the wired communication type cell module, the wireless communication type cell module, and the combined communication type cell module further include
a cell including a cell module positive terminal connected with the battery positive terminal and a cell module negative terminal connected with the battery negative terminal,
a DC power terminal connected with the battery positive terminal and the battery negative terminal to receive battery voltage, and
a DC-DC converter positioned between the cell and the DC power terminal and charging DC power received from the DC power terminal in the cell.

12. The battery pack of claim 11, wherein:
the wired communication type cell module further includes
a controller power terminal connected with the power connector to supply the power received from the external equipment to the CPU and the wired communication module,
the wireless communication type cell module further includes
a controller power terminal connected with the power connector to supply the power received from the external equipment to the CPU and the wireless communication module,
the combined communication type cell module further includes
a controller power terminal connected with the power connector to supply the power received from the external equipment to the CPU, the wireless communication module and the wired communication module,
the wired communication terminal, the controller power terminal and the DC power terminal are connected with each other between the combined communication type cell module and at least one wired communication type cell module,
the wireless communication terminal, the controller power terminal and the DC power terminal are connected with each other between the combined communication type cell module and at least one wireless communication type cell module, and
the controller power terminal and the DC power terminal are connected with each other between the at least one wired communication type cell module and the at least one wireless communication type cell module.

13. The battery pack of claim 9, further comprising:
a battery positive terminal and a battery negative terminal;
a power connector for supplying the power from the external equipment; and
an external power terminal,
wherein the wired communication type cell module, the wireless communication type cell module, and the combined communication type cell module
charge the cell by battery voltage received from the external power terminal, and
supply the power of the CPU as the power received from the power connector.

14. The battery pack of claim 13, wherein:
the wired communication type cell module, the wireless communication type cell module and the combined communication type cell module further include
a cell including a cell module positive terminal connected with the battery positive terminal and a cell module negative terminal connected with the battery negative terminal,
an AC power terminal connected with the external power terminal to receive external AC voltage, and
an AC-DC converter positioned between the cell and the AC power terminal and converting AC power received from the AC power terminal to DC power to charge the cell.

15. The battery pack of claim 14, wherein:
the wired communication type cell module further includes
a controller power terminal connected with the power connector to supply the power received from the external equipment to the CPU and the wired communication module,
the wireless communication type cell module further includes
a controller power terminal connected with the power connector to supply the power received from the external equipment to the CPU and the wireless communication module,
the combined communication type cell module further includes
a controller power terminal connected with the power connector to supply the power received from the external equipment to the CPU, the wireless communication module and the wired communication module,
the wired communication terminal, the controller power terminal and the AC power terminal are connected with each other between the combined communication type cell module and at least one wired communication type cell module,
the wireless communication terminal, the controller power terminal and the AC power terminal are connected with each other between the combined communication type cell module and at least one wireless communication type cell module, and
the controller power terminal and the AC power terminal are connected with each other between the at least one wired communication type cell module and the at least one wireless communication type cell module.

16. A cell module, comprising:
a cell including a cell module positive terminal and a cell module negative terminal to be charged and discharged;
a CPU executing battery management system software controlling charging and discharging of the cell; and
a communication module and a communication terminal downloading the battery management system software wiredly or wirelessly to transfer the battery management system software to the CPU.

17. The cell module of claim 16, wherein:
the communication module and the communication terminal
communicates with other cell modules wiredly or wirelessly to transceive the control command.

18. The cell module of claim 17, further comprising:
a power terminal to which power is applied from the outside;
a converter converting the power to charge the power in the cell;
a switch positioned between the cell and the converter to be turn on or off according to a control of the CPU;
a current sensor positioned between the cell and the converter to output measured current to the CPU; and
a temperature sensor measuring a temperature of the cell to output the measured temperature to the CPU.

19. A cell module assembly, comprising:
two or more cell modules which include a battery cell including a cell module positive terminal and a cell module negative terminal and having a predetermined shape; and
a printed circuit board connected with the battery cell on one side of the battery cell and including a circuit unit for charging and discharging the battery cell, wherein the cell modules are disposed in two or more cell trays.

20. The cell module assembly of claim 19, wherein:
the battery cell has a hexahedral shape, and
the printed circuit board
is coupled to four left and right sides or front and rear sides of the battery cell.

21. The cell module assembly of claim 20, wherein:
the cell module positive terminal and the cell module negative terminal are positioned on a different surface from the printed circuit board.

22. The cell module assembly of claim 21, wherein:
a plurality of cell trays are stacked.

23. The cell module assembly of claim 22, wherein:
the plurality of cell trays are stacked in a drawer structure.
